(19) United States
(12) Patent Application Publication
(10) Pub. No.: US 2004/0137782 A1
(43) Pub. Date: Jul. 15, 2004

(54) Jack plug

(76) Inventor: Bernhard Weingartner, Feldkirch (AT)

Correspondence Address: Gerald H. Kiel, Esq., REED SMITH LLP, 599 Lexington Avenue, New York, NY, 10022-7650, US

(21) Appl. No.: 10/465,072

(22) Filed: Jun. 19, 2003

(30) Foreign Application Priority Data
Jan. 9, 2003 (AT) A 18/2003

(51) Int. Cl. H01R 4/24; H01R 4/26; H01R 11/20

(52) U.S. Cl. 439/404

(57) ABSTRACT

A jack plug for a cable having a center conductor and at least one shielding conductor surrounding the center conductor comprises a plug shaft having the electric plug contact elements at the front side of the jack plug, a receiving space which opens toward the rear of the jack plug and in which the cable can be inserted and in which the inserted cable can be fixed, electric cable contact elements which communicate with the plug contact elements for making electrical contact with the conductors of the cable, at least one of which electric cable contact elements has a knife edge or tip by which a conductor ending at the front end of the inserted cable can make contact, wherein at least one electric cable contact element having a knife edge or tip is mounted so as to be displaceable and a spring is provided for pushing the cable contact element against the conductor of the inserted cable.

### CROSS-REFERENCE TO RELATED APPLICATION

This application claims priority of Austrian Application No. A 18/2003, filed Jan. 9, 2003, the complete disclosure of which is hereby incorporated by reference.

### BACKGROUND OF THE INVENTION

a) Field of the Invention

The invention is directed to a jack plug for a cable having a center conductor and at least one shielding conductor surrounding the center conductor, with a plug shaft having the electric plug contact elements at the front side of the jack plug, and with a receiving space which opens toward the rear of the jack plug and in which the cable can be inserted and in which the inserted cable can be fixed, the jack plug having electric cable contact elements which communicate with the plug contact elements for making electrical contact with the conductors of the cable, at least one of which electric cable contact elements has a knife edge or tip which contacts a conductor ending at the front end of the inserted cable.

b) Description of Related Art

There are many different known constructional forms of jack plugs in which an onion-shaped contact or contact bulb is provided as first contact element at the free end of the jack plug on the plug-in side and a shaft serving as additional contact element is provided adjoining the contact bulb with the intermediary of an insulator. Jack plugs of this type are used, for example, in audio engineering, particularly in entertainment electronics, e.g., for connecting electric guitars and for connecting various equipment directly or by way of patch bays.

In the jack plug known from U.S. Pat. No. 2,610,223, solder lugs are provided for the center conductor as well as for the shielding conductor. The following work steps are required for connecting a cable to this jack plug: First, the outer insulation of the cable which is usually made of elastomer plastic, i.e., the cable jacket, must be removed. Next, the cable shielding which is usually in the form of a tightly woven wire mesh or foil must be slit open and the opened shielding must be twisted into a shape allowing for soldering. The inner conductor which is usually formed of flexible wire or Litz conductors to achieve a desired flexibility is then exposed, and the inner insulation surrounding the center conductor must be removed. For electrical connection of the cable which has been prepared in this way, the inner conductor is first soldered to the solder lug which is electrically connected to the contact bulb, the shielding conductor is then connected to the shaft by soldering the shielding conductor to the solder lug connected to the shaft. In addition, a strain relief cooperating with the outer insulation is usually provided in order to divert tensile forces from the contact-making connections.

Therefore, a time-consuming work process comprising multiple steps is required for attaching the cable to a conventional jack plug of the type mentioned above.

A jack plug which enables a solderless connection of the cable to the plug is known from DE 42 39 066 C2. However, the preparation of the cable is also time-consuming. The exposed shielding conductor must be turned down over the outer insulation and the center conductor must be freed of inner insulation in its very front area and then bent. The bent center conductor is inserted into a piece of tubing communicating electrically with the contact bulb and is received therein so as to be clamped by an annular bead. The turned down shielding conductor is inserted into a receiving sleeve which is provided with slots proceeding from its rear end so as to form springing-elastic tongues. By screwing on a grip sleeve, the springing-elastic tongues are pressed against the shielding conductor, which produces contact of the shielding conductor and a strain relief.

A jack plug of the type mentioned above is known from U.S. Pat. No. 4,352,240 A. In this jack plug, tips are provided for contacting the center conductor on one side and the shielding conductor on the other. In order to connect the cable to the cable contact elements, the cable is squarely severed (vertical to its longitudinal axis) and inserted into the receiving space until the contact tips for the center conductor and shielding conductor contact these conductors. The tip for contacting the center conductor is arranged on a connection part which is connected by its front end to the contact bulb and which protrudes through the shaft into the receiving space, and the tips for contacting the shielding conductor are arranged at a sheet metal part placed in the receiving space for the cable. The cable which is inserted into the receiving space and which makes contact by means of the tips is fastened in the receiving space, for example, by crimping.

This previously known jack plug is disadvantageous in that a reliable and, above all, durable contacting of the conductors of the cable can not be guaranteed. The contacting force acting between the contact tips and the conductors is exerted by the elasticity of the material of the inner and outer insulation of the cable in particular. This contact force is not sufficient for a reliable contact and also decreases over the course of time. Most of all, when the tips are not pressed far enough into the front end of the cable, which is hard to control during assembly, there can be no reliable long-term contact.

### OBJECT AND SUMMARY OF THE INVENTION

An important object of the invention is to provide a jack plug of the type mentioned above that achieves a contact of the conductors of the cable which, above all, is more dependable over a longer period of use. According to the invention, this is accomplished by means of a jack plug for a cable having a center conductor and at least one shielding conductor surrounding the center conductor which comprises a plug shaft having electric plug contact elements at the front side of the jack plug, a receiving space which opens toward the rear of the jack plug and in which the cable can be inserted and in which the inserted cable can be fixed and electric cable contact elements which communicate with the plug contact elements for making electrical contact with the conductors of the cable. At least one of the electric cable contact elements has a knife edge or tip by which a conductor ending at the front end of the inserted cable can make contact. At least one electric cable having a knife edge or tip is mounted so as to be displaceable. A spring is provided for pushing the cable contact element against the conductor of the inserted cable.

Inserting a cable into the receiving space compresses the spring of the at least one spring-loaded cable contact having a knife edge or tip.

The tip or the knife edge of the cable contact element can be pressed more or less far into the front end of the cable and associated conductor. In principle, it is sufficient when the tip or knife edge just contacts the front side of the conductor. In this state, i.e., when the spring of the at least one cable contact element is tensioned, the cable that is contacted in this way is fixed in the jack plug. A reliable contact is achieved between the cable contact element and the conductor by means of this spring tensioning. The contact force has a defined value that is determined by the spring tensioning. The contact force is also maintained throughout the period of use of the jack plug.

All cable contact elements preferably have a knife edge or tip and are supported so as to be displaceable toward the front of the cable connector against the force of a spring. A cable can then be connected to the jack plug in a very simple manner in that the squarely cut cable is inserted into the receiving space and pressed in until the springs of the cable contact elements are tensioned, wherein a defined insertion force can be provided and the cable is fixed in the receiving space in the tensioned state of the spring, so that it can no longer be pulled out from the receiving space and jack plug and the springs remained tensioned.

The contacting cable can be fixed in the jack plug in different ways. For example, the receiving sleeve could be divided into individual tongues in its rear area by axially extending slots proceeding from its rear side, which tongues are pressed against the cable jacket by screwing on a grip sleeve. A strain relief device of this kind could be constructed as shown in DE 42 39 066 C2. However, in the present case, no contacting of the shielding conductor need be carried out through the strain relief device.

In an advantageous embodiment example of the invention, a receiving sleeve having the receiving space is crimped for fixing the contacted cable in the receiving space. For example, a hexagonal crimping can be provided, that is, the cross section of the receiving sleeve is pressed into a hexagonal outer shape. It is also possible to produce a gastight connection between the receiving sleeve and the outer insulator of the connected cable by crimping in this way, so that the contact areas between the cable and the connector can be enclosed in a gastight and, therefore, corrosion-proof manner.

Further, in order to protect against corrosion, the at least one knife edge or tip for the center conductor or the at least one knife edge or tip for the shielding conductor can gold plated by electroplating.

Further advantages and details of the invention are described in the following with reference to the embodiment example shown schematically in the accompanying drawings, further objects of the invention also following therefrom.

### BRIEF DESCRIPTION OF THE DRAWINGS

In the drawings:

FIG. 1 shows a schematic longitudinal central section through a jack plug according to the invention;

FIG. 2 shows a magnified view of the contact area of the jack plug with a cable to be connected to it;

FIG. 3 shows an insert with crown-like serration for contacting the shielding conductor; and

FIG. 4 shows a schematic view of a part of the plug with a connected cable.

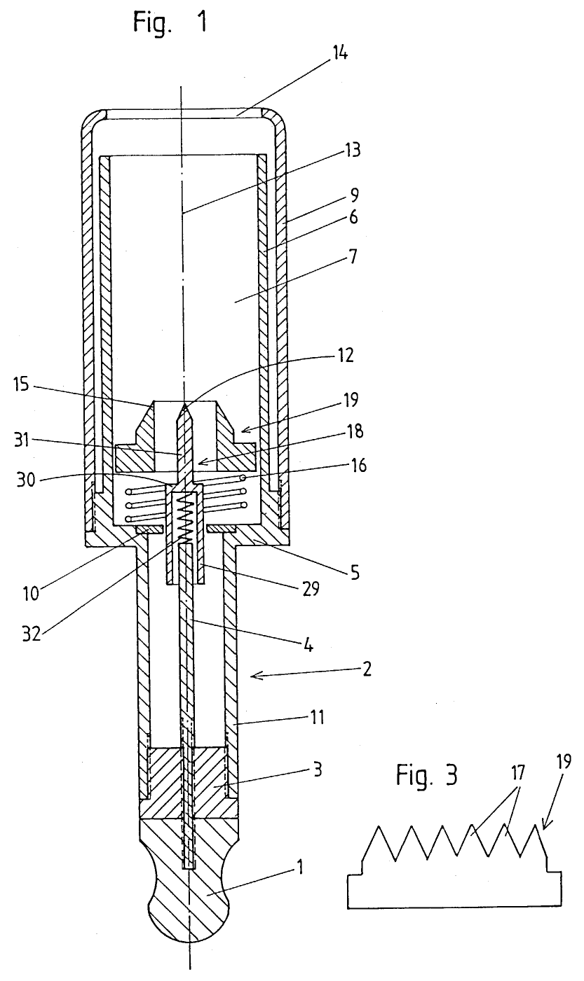

### DESCRIPTION OF THE PREFERRED EMBODIMENTS

Within the framework of the present application, the front side of the plug is the side facing the insertion side of the plug, and the rear side is the side facing the cable to be connected.

The jack plug has a plug shaft 2 which can be inserted into a corresponding insertion opening of a receiving bush for the jack plug. The receiving bush which is not shown in the drawing can be constructed in a conventional manner. A contact bulb 1 is arranged at the free end of the plug shaft 2 so as to be distanced from a tubular shaft part 11 by an insulating piece 3. The contact bulb 1 is electrically connected to a pin-shaped connection part 4 which is screwed into a threaded bore hole at the rear of the contact bulb 1, for example. The connection part 4 extends through the tubular shaft part 11 at a distance from the inner wall of the latter. An insulating tube can also be added between the shaft part 11 and connection part 4. The insulating piece 3 can have a continuation which protrudes into the shaft part 11 and which is provided with an external thread which is screwed into an internal thread at the front end of the shaft part 11. The central opening of the insulating piece 3 through which the connection part 4 extends can have an internal thread which cooperates with an external thread of the connection part 4. In this way, the contact bulb 1, the insulating piece 3, the connection part 4 and the shaft part 11 can be held together, although it would also be conceivable and possible to hold these parts together in some other way.

The metal shaft part 11 is fastened to a metal carrier part 5, e.g., is constructed integral therewith. The carrier part 5 is connected at its rear side to a metal receiving sleeve 6, for example, by means of a screw connection or an integral construction. The receiving sleeve 6 has a cylindrical receiving space 7 which opens toward the rear of the jack plug. An external thread 8 is provided at the carrier part 5 and/or at the receiving sleeve 6, and a grip sleeve 9 made of metal or plastic can be screwed onto the external thread 8. The grip sleeve 9 has at its rear end an insertion opening 14 for a cable 20 to be connected to the jack plug. Another connection could also be provided between the carrier part 5 or receiving sleeve 8 and the grip sleeve 9 in place of the external thread 8. The grip sleeve 9 could also be omitted. If desired, the receiving sleeve 6 could also be surrounded by an injection-molded part as a jacket, for example.

A cable 20 to be connected to the jack plug has a center conductor 21 which is formed particularly as Litz conductor and is enclosed by inner insulation 22. A shielding conductor 23 surrounding the inner insulation is connected externally, for example, as a wire mesh or in the form of a foil. The outer jacket of the cable 20 is formed by an external insulator 24.

The plug contact elements of the jack plug which are to be contacted by the corresponding mating contact elements of the connector bush provided for the jack plug are formed by the contact bulb 1 and the shaft part 11. Electrical cable contact elements 18, 19 are provided for electrically connecting the conductors of the cable to the plug contact elements. The cable contact element 18 has a tubular portion 29 which is open toward the front of the jack plug and closed on its rear side by a base 30. A pin 31 with a tip 12 adjoins the rear of the base 30. The rear end of the connection part 4 an be inserted into the tubular portion 29, wherein a spring 32 formed as a helical spring is arranged between the connection part 4 and the base 30 and is supported at these two parts.

The cable contact element 19 is formed by an insertion part which is inserted into the receiving space 7 and provided at its rear side with a knife edge 15 in the form of a ring knife surrounding the longitudinal axis 13 of the jack plug concentrically. A spring 16 is provided between the cable contact element 19 and the carrier part 5 and is supported at these two parts.

In this way, the two cable contact elements 18, 19 are mounted so as to be displaceable toward the front of the jack plug against the force of a spring 32, 16, respectively.

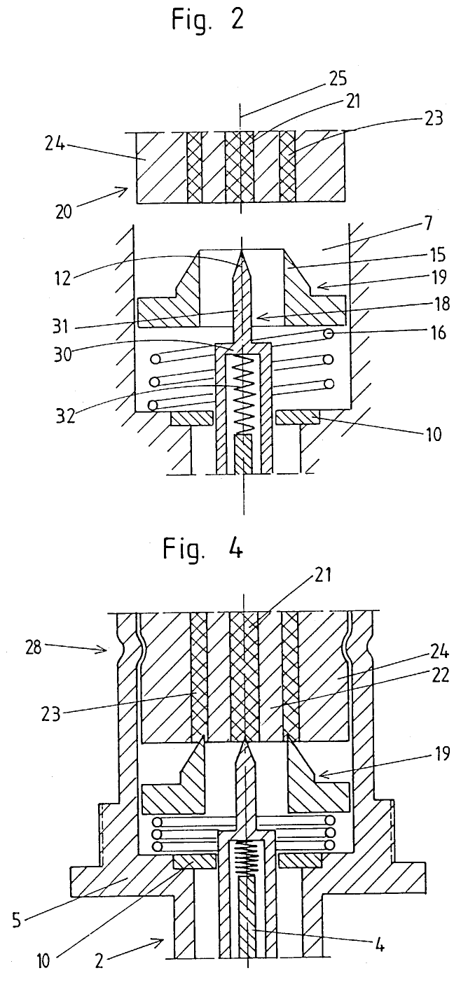

In order to fit the cable 20 to the jack plug, the cable 20 is severed squarely and vertical to its longitudinal axis 25 as is shown in FIG. 2. The cable 20 is pulled through the insertion opening 14 into the grip sleeve 9 and can be inserted with slight play into the receiving sleeve 6, i.e., the inner diameter of the receiving sleeve 6 is only slightly greater than the outer diameter of the outer insulation 24 of the cable 20. The cable 20 is centered in that the central longitudinal axis 25 of the cable 20 coincides at least approximately with the central longitudinal axis 13 of the receiving sleeve 6. The cable 20 is inserted into the receiving space 7 of the receiving sleeve 6 until the springs 32 and 26 are at least partially compressed, preferably at least one of these springs being completely compressed, the tip 12 is electrically connected with the center conductor 21 and the ring knife 15 is electrically connected with the shielding conductor 23. In so doing, the tip 12 and the ring knife 15 are preferably pressed into the front end of the cable and the respective conductor, for example, by several millimeters approximately.

The distance of the knife edge 15 from the central longitudinal axis 13 of the receiving sleeve 6 at least substantially corresponds to the distance between the shielding conductor 23 of the cable 20 and the central longitudinal axis 25 of the cable 20, so that an electrical contact is ensured.

Subsequently, with the springs 32, 16 under tension, the cable is fixed in the receiving space 7 in such a way that the cable is not displaceable relative to the receiving space, for example, in that the receiving space 6 is provided with a crimping 28 as is indicated schematically in FIG. 4. The strain relief of the cable is also produced in this way. In doing so, a gastight connection can also be formed between the outer insulator 24 and the receiving sleeve 6.

Instead of a ring knife 15, a plurality of tips 17 could also be provided for contacting the shielding conductor, as is shown in FIG. 3, these tips 17 being arranged at a distance from one another in circumferential direction substantially along an imaginary circle surrounding the central longitudinal axis 13 of the receiving sleeve 6, its center being formed by the longitudinal axis 13. The distance between the tips 27 and central longitudinal axis 13 of the receiving sleeve 6 again corresponds to the distance between the shielding conductor 23 of the cable 20 and the central longitudinal axis 25 of the cable 20. In the embodiment example according to FIG. 3, these tips 17 are arranged at a sleeve-shaped cable contact element 19 with crown-like serration. These tips 17 can also be laterally offset somewhat relative to the above-mentioned imaginary circle, for example, so as to alternate in both directions. This enlarges the contact area for the shielding conductor 23 in order to correct for manufacturing tolerances or possible lateral offset due to the play between the cable 20 and the receiving sleeve 6. In addition, the serrations 17 can be turned somewhat relative to the imaginary circle mentioned above, for example, so as to alternate in both directions.

Instead of the tip 12 for contacting the center conductor, a knife edge formed, e.g., in the shape of a cross as seen from the top, could also be provided so that the surface of contact with the center conductor 21 could be enlarged.

Although it is preferable that the cable contact element 18 for the center conductor 21 of the cable 20 as well as the cable contact element 19 for the shielding conductor 23 are constructed so as to be spring-mounted, it would also be conceivable and possible in principle for only one of these cable contact elements to be displaceable against the force of a spring and for the other to be immovable. It is conceivable in principle and would also be possible that the cable has more than two conductors which terminate at defined locations at its front end, for example, a center conductor and two coaxial conductors which are separated from one another by insulation and which surround the center conductor annularly in section, in which case corresponding cable contact elements of the jack plug which are electrically connected to plug contact elements would be provided.

As follows from the preceding description, the field of the invention is not limited to the embodiment examples shown herein, but should be defined with reference to the appended claims together with their full range of possible equivalents in accordance with the true spirit and scope of the invention.

### REFERENCE NUMBERS

1 contact bulb

2 plug shaft

3 insulating piece

4 connection part

5 carrier part

6 receiving sleeve

7 receiving space

8 external thread

9 grip sleeve

10 insulating part

11 shaft part

12 tip

13 longitudinal axis

14 insertion opening

15 knife edge

16 spring

17 tip

18 cable contact element

19 cable contact element

20 cable

21 center conductor

22 inner insulation

23 shielding conductor

24 outer insulation

25 central longitudinal axis

26 contact shoulder

28 crimping

29 portion

30 base

31 pin

32 spring

What is claimed is:

1. A jack plug for a cable having a center conductor and at least one shielding conductor surrounding the center conductor, comprising:
a plug shaft having electric plug contact elements at the front side of the jack plug;
said jack plug having a receiving space which opens toward the rear of the jack plug and in which the cable can be inserted and in which the inserted cable can be fixed;
electric cable contact elements which communicate with the plug contact elements for making electrical contact with the conductors of the cable;
at least one of which electric cable contact elements having a knife edge or tip by which a conductor ending at the front end of the inserted cable can make contact;
at least one electric cable contact element having a knife edge or tip being mounted so as to be displaceable; and
a spring being provided for pushing the cable contact element against the conductor of the inserted cable.

2. The jack plug according to claim 1, wherein the plug shaft has at its free end a contact bulb to which a connection part extending through a shaft part is connected, and a spring is arranged between the connection part and a cable contact element with a tip or knife edge for contacting the central conductor of the cable.

3. The jack plug according to claim 2, wherein the connection part projects into a tubular portion of the cable contact element in which the spring is arranged.

4. The jack plug according to claim 1, wherein a cable contact element is formed as an insert arranged in the receiving space for contacting a shielding conductor of the cable, and a spring is arranged between the cable contact element and a carrier part for the plug shaft.

5. The jack plug according to claim 1, wherein all cable contact elements have a knife edge or tip, by which a respective conductor terminating at the front end of an inserted cable can be contacted.

6. The jack plug according to claim 1, wherein all electric cable contact elements having at least one knife edge or tip are displaceable toward the front side of the cable plug against the force of a spring.

7. The jack plug according to claim 1 to which a cable is fitted, wherein the spring of the at least one spring-mounted contact element is tensioned and the cable contact element is pretensioned in the direction of the cable.

8. The jack plug according to claim 7, wherein the cable is fastened in the receiving space by crimping a receiving sleeve having the receiving space.
